(19) United States
(12) Patent Application Publication
(10) Pub. No.: US 2020/0149927 A1
(43) Pub. Date: May 14, 2020

(54) INDUCTIVE DISPLACEMENT SENSOR

(71) Applicants: YANCHEN ZHANG, SAN CLEMENTE, CA (US); MENG ZHANG, SAN CLEMENTE, CA (US); ZHONGYI YANG, DONGGUAN CITY (CN)

(72) Inventors: YANCHEN ZHANG, SAN CLEMENTE, CA (US); MENG ZHANG, SAN CLEMENTE, CA (US); ZHONGYI YANG, DONGGUAN CITY (CN)

(21) Appl. No.: 16/191,423

(22) Filed: Nov. 14, 2018

(51) Int. Cl. G01D 5/20

(52) U.S. Cl. CPC G01D 5/2086

(57) ABSTRACT

The present invention relates generally to a new type of inductive displacement sensor, composed of a scale and a winding element. The scale is a conductor with two rows of parallel and uniform distribution of a grid. The scale and winding elements can be moved in the direction of the grid distribution. The winding element is spaced on opposing face of the scale; the winding elements include the first winding, the second winding, the third winding and the fourth winding. The first winding and the second winding cross wind to form the driving winding element, thereby forming the pattern, third winding fourth cross winding constitute two sensing winding elements, with the two sensing winding elements along the direction perpendicular to the grid distribution of each side of the element distribution in driving winding forming patterns. One end of the first winding is connected to one end of the second winding and form a common end which is connected with the electronic device. Both the sensing windings and the driving windings have a space along the grid distribution and aligned along the grid distribution. The present invention reduces the direct coupling between drive winding element and the sensing winding elements, reducing the potential for incompatability of assembling clearance error, and to a certain extent, reduces distortion measurements, enhancing the stability of the sensor and the accuracy of measurement.

### PRIORITY DATE, CROSS-REFERENCE TO RELATED APPLICATION

The present application is related to and claims the benefit and priority of U.S. Provisional Patent Application No. 62/612,444, filed Dec. 30, 2017, the entirety of which is hereby incorporated herein by reference.

### BACKGROUND OF THE INVENTION

### Field of the Invention

This invention is in the field of inductive sensor technology, and includes a scale and a winding element, and the described scale is a conductor with two lines in parallel and uniform distribution. The horizontal spacing between the two adjacent grids forms a T shape, and upper and lower grids along the grid distribution direction, which are spaced offset of each other. The scale and winding elements may move in the direction of the grid distribution. The two sensing winding elements have identical patterns and are distributed in parallel with the drive winding elements.

### Brief Description of the Related Art

In existing technology, the scale of a typical inductive displacement sensor utilizes a line of uniform distribution of conductive grid structure. The distance between two adjacent grid forms a T shape and winding elements of each winding are connected in Y type shape. All windings to scale the entire width of the interweave in the same area. The Y-type method typically used have all the windings sharing the same magnetic field, resulting in greater mutual coupling between the windings, and each winding assumes two functions simultaneously (both the drive winding and the sensing windings), resulting in larger winding drive signal and larger sensor signal generated by the direct coupling, reducing strength of the useful signal, causing distortion in measurement, reducing the accuracy and the stability of the sensor.

In another embodiment, the scale is a line of uniform distribution of lattice structure of the conductive body, and the distance between two adjacent grids is T type. In such a T type, all windings are shaped in Z shaped intertwining each other and. Driver and sensing windings are separated. Such formation only covers the grid half a cycle, with each winding and the coupling degree of the scale decreases. But even if there is some direct coupling between the separated windings, the strength of the useful signal is typically reduced, and the measurement distortion that is caused, reduces the accuracy of the measurement and the stability of the sensor are also reduced.

### SUMMARY OF THE INVENTION

The purpose of this invention is to provide a new type of inductive displacement sensor to reduce the measurement distortion to a certain extent and improve the stability and accuracy of the sensor.

In order to solve the technical problems in a typical sensor currently on the market, the invention provides a new type of inductance displacement sensor, including the scale and winding element. The scale is a conductor with two lines of parallel and uniform distribution of the grid (2). The horizontal spacing between two adjacent grid is T, and upper and lower two grids along the grid distribution direction are offset each other T/2, upper and lower two rows of The scale and winding elements can be moved in the direction of the grid distribution. The winding element faces the scale. The winding elements include the first winding, the second winding, the third winding and the fourth winding. The first winding and the second winding form the driving winding element. The third and fourth windings cross each other constitute two sensing winding elements. The two sensing winding elements along the direction perpendicular to the grid distribution distribution on both sides of the driving winding element respectively. The two sensing winding elements are same. The end of the first winding is connected with the end of the second winding, and their common end is connected with the power negative terminal. Both the sensing windings and the driving windings have a space cycle of 2T along the grid distribution, and aligned along the grid distribution.

Optional embodiment: the sensing windings are parallel to the driver winding elements.

Another Optional embodiment: the sensing winding element and the driver winding element are distributed to the scale.

Another Optional embodiment: the drive winding element is surrounded by the sensing winding element to the positive distribution.

The present invention provides a new type of inductive displacement sensor described in scale with two lines parallel to the uniform distribution of conductive grid structure, horizontal spacing between two adjacent grid is T, upper and lower two grids along the grid distribution direction are offset of each other.

### BRIEF DESCRIPTION OF THE DRAWINGS

FIG. 1, shows the current relationship diagram of a new type of coolant proof inductive displacement sensor provided by the invention.

FIG. 2a, shows the first embodiment of a new type of coolant proof inductive displacement sensor provided by the invention.

FIG. 2b, shows the second embodiment of a new type of coolant proof displacement sensor provided by the invention.

FIG. 2c, shows the third embodiment of a new type of coolant proof displacement sensor provided by the invention.

FIG. 3, shows a schematic diagram of the circuit structure used in the electronic devices used in the invention to generate the signal Q1 and Q2.

FIG. 4, shows a schematic diagram of the circuit in FIG. 2a, FIG. 2b, FIG. 2c, that is converted into signal LA by the electronic device embodiment used in this invention.

FIG. 5, shows a schematic diagram of the circuit structure of the signal to be converted into signal LB by the signal Q2 generated by FIG. 2a, FIG. 2b, FIG. 2c showing the electronic device embodiment used in the invention.

FIG. 6, shows a schematic diagram of the sensing signal sampling circuit showing the electronic device embodiment used in this invention.

FIG. 7, shows a schematic diagram of the winding elements of the inductive displacement sensor provided in this invention.

FIG. 8, shows the realization circuit and waveform schematic of the actuator of the inductive displacement sensor provided by the invention.

FIG. 9, shows the sampling timing waveform of the inductance displacement sensor provided by the invention.

FIG. 10, shows the schematic diagram of the linear scale used in the first embodiment and the second embodiment of a new type of inductive displacement sensor provided by the invention.

FIG. 11, shows the circular scale the inductive displacement sensor provided by the invention.

### DESCRIPTION OF PREFERRED EMBODIMENTS

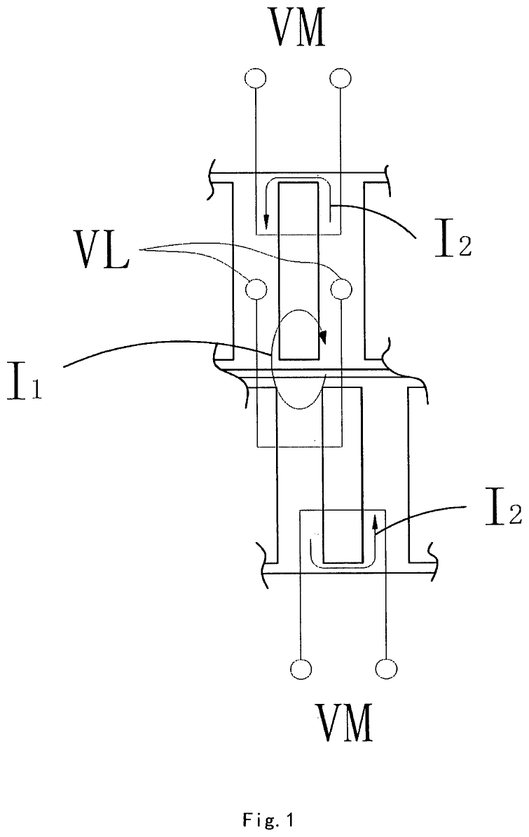

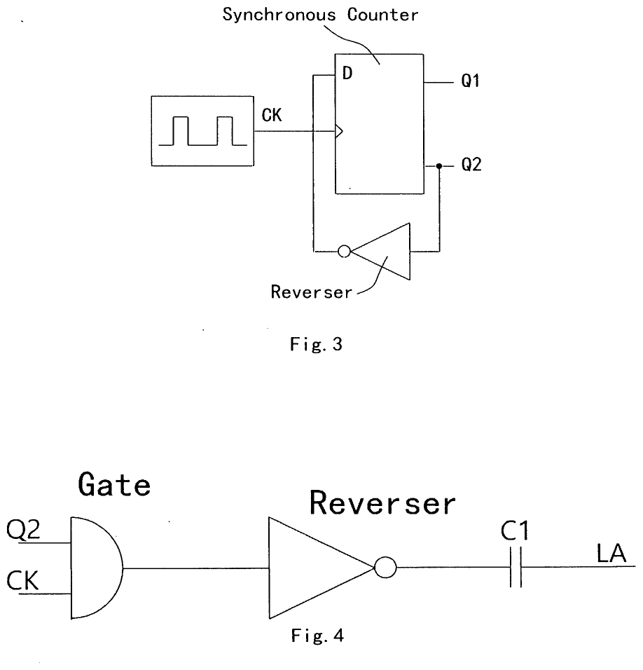

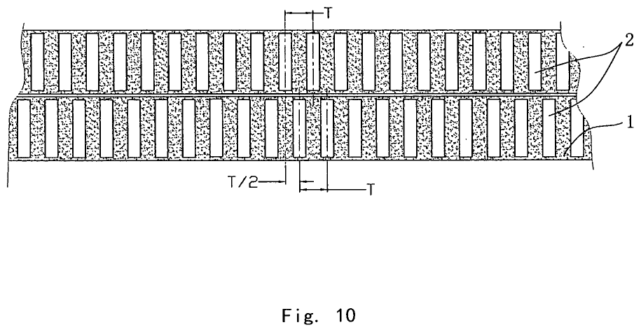

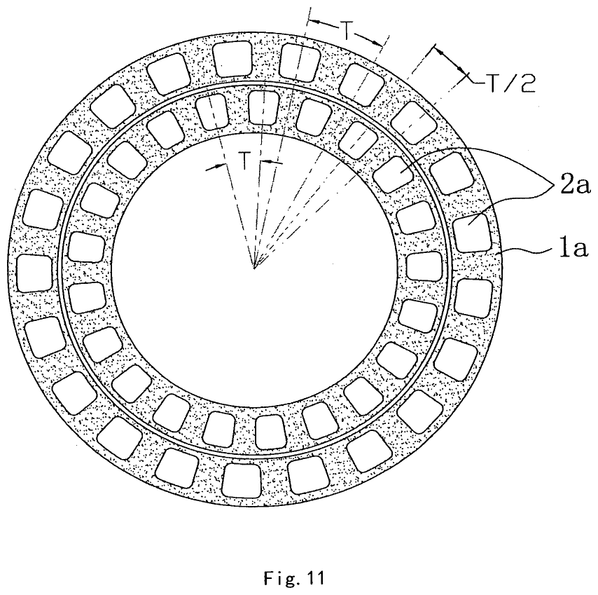

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner. Referring to the drawing figures, like reference numerals designate identical or corresponding elements throughout the several figures. As shown and described in FIG. 1 through FIG. 11.

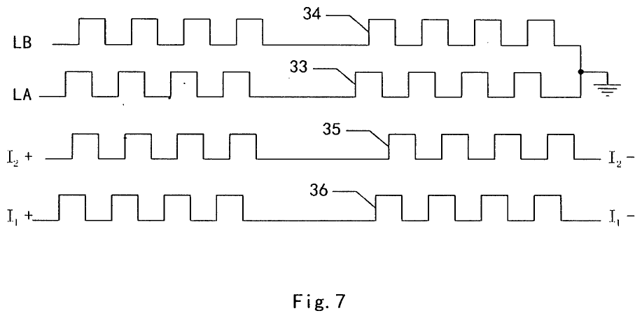

FIG. 1 shows the present invention with driver within the current sensing windings of the winding current. FIG. 1 also shows the relationship between the current in sensing windings and the current in the driving winding. Driving voltage VL can be a series of rectangular pulses, used to connect to terminal LA in FIG. 7, and winding 33 forms pulse current I1. Pulse current I1 makes scale to produce induced current I2, inconsistency in winding I1+ terminal current I2 pulse voltage VM, become scale and winding elements relative movement along the direction of the grid distribution function. VM is initialized as voltage is 0 (zero).

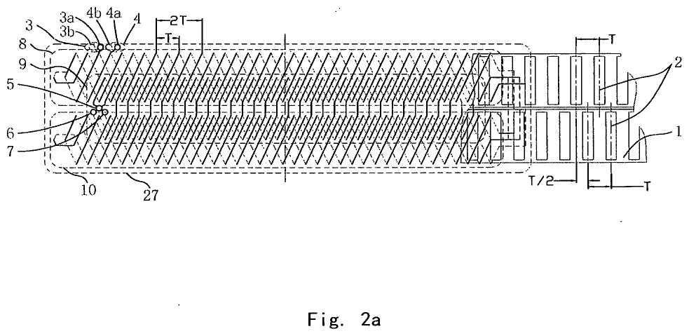

FIG. 2a shows one embodiment of the invention. The inductive displacement sensor includes scale 1 and winding element 27. Scale 1 with two lines parallel to the uniform distribution of conductive grid structure, level spacing between two adjacent grid is T, upper and lower two grids along the grid distribution direction are offset of each other T/2. The scale 1 and the winding element 27 can be moved in the direction of the grid distribution. Winding element 27 faces scale 1; The winding element 27 includes the first winding 6, the second winding 7, the third winding 3, and the fourth winding 4.

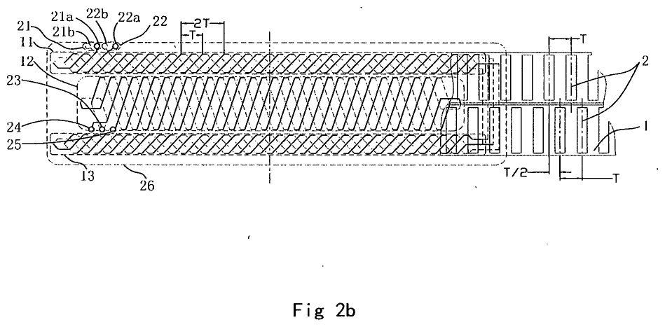

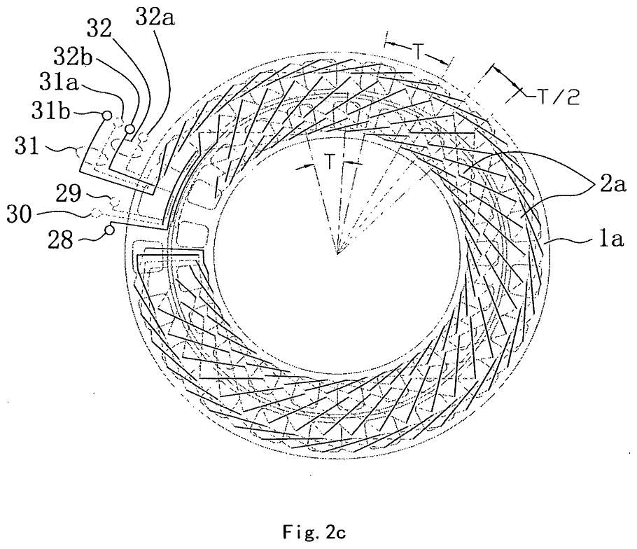

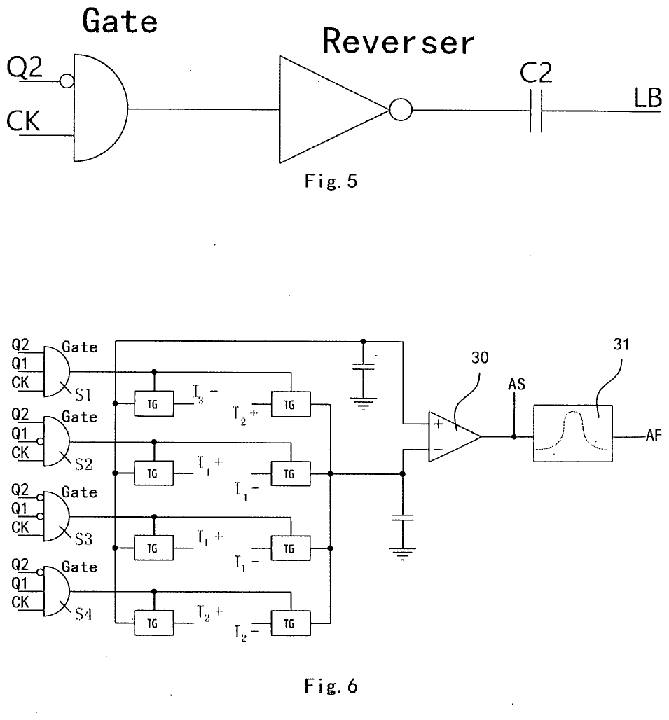

The first winding 6 and the second winding 7 along the grid distribution are offset of each other T/2 and cross winding form drive winding element: pattern 9, faced with the scale 1, partly cover upper and lower two lines of scale 1; the third winding 3 and the fourth winding 4 along the grid distribution direction of are offset each other T/2 and cross winding constitute two pattern identical sensing windings elements: pattern 8, 10, face to the scale 1, aligned along the grid direction, and parallel to drive winding element distribution, covering ascending grid and descending scale 1; pattern 9 overlaps with pattern 8 and pattern 10, making the driver winding elements have the largest coverage area of scale 1, which enhances the coupling current on the scale 1, when each winding only cover the location of the grid T/2, the minimum coupling strength, however, when ascending grid only covered by winding T/2 position, relative offset downward grid still provide enough T/2 coupling strength; the end of first winding 6 and the end of the second winding 7 connection of common end 5, and connected to the power of negative, the head of the winding 6 (LA) connects the inverter shown in FIG. 3, and the head of the winding 7 (LB) connects the inverter shown in FIG. 4; the head of the third winding 3b connects to I1+ shown in FIG. 6, at the end of the third winding 3a connects to I1− shown in FIG. 6, the head of the fourth winding 4b connects to I2+ in shown by FIG. 6, the end of the fourth winding 4a connects to I2− shown in FIG. 6.

FIG. 2b shows another embodiment of the present invention, the inductive displacement sensor includes scale 1 and winding element 26, scale 1 with two rows parallel to the uniform distribution of conductive grid structure, level spacing between two adjacent grid is T, upper and lower two grids along the grid distribution direction are offset of each other T/2; The scale 1 and the winding element 26 are moveable in the direction of the grid distribution. Winding element 26 faced to scale 1. The winding element 26 includes the first winding 24, the second winding 25, the third winding 21, and the fourth winding 22, among them:

The first winding 24 and the second winding 25 along the grid distribution offset each other T/2 and cross winding form drive winding element: pattern 12, faced with the scale 1, partly cover upper and lower two lines of scale 1; the third winding 21 and the fourth winding 22 along the grid distribution direction are offset each other T/2 and cross winding constitute two pattern identical sensing windings elements: pattern 11, 13, face to the scale 1, aligned along the grid direction, and parallel to drive winding element distribution, covering ascending grid and descending scale 1; pattern 12 and pattern 11, 13 parallel distribution. when each winding only cover the location of the grid T/2, the minimum coupling strength, however, when ascending grid only covered by winding T/2 position, relative offset downward grid still provide enough T/2 coupling strength; the end of first winding 24 and the end of the second winding 25 form the common end 26, and connected to the power of negative, the head of the winding 24 (LA) connects the inverter shown in FIG. 3, and the head of the winding 25 (LB) connects the inverter shown in FIG. 4; the head of the third winding 21b connects to I1+ shown in FIG. 6, at the end of the third winding 21a connects to I1− shown in FIG. 6, the head of the fourth winding 22b connects to I2+ in shown by FIG. 6, the end of the fourth winding 22a connects to I2− shown in FIG. 6.

FIG. 2c shows another embodiment of the present invention, wherein the inductive circular displacement sensor includes circular scale 1c and 2c circular winding element 2c, scale 1a is a conductive body with a uniform distribution of fan-shaped grids on the circumference of a circle, the angle between the two adjacent grid is T, circumferential direction of the upper and lower two grids along the grid distribution direction offset each other T/2; the scale 1a and winding elements can be rotated relative to the circumference of the grid distribution. The winding element is faced to scale 1a; the winding elements include the first winding 28, the second winding 29, the third winding 31, and the fourth winding 32, among them:

The first windings 28 and the second winding 29 are offset by the grid distribution in the direction of T/2 and cross winding to form the driving winding element, faced to the scale 1a, and partial cover scale 1a upper and lower two lines of scale; the third winding 31 and the fourth winding 32 along the grid distribution direction of offset each other T/2 and cross winding constitute two drive winding element, faced to the scale 1a, aligned along the grid circular direction, covering ascending grid and descending circular scale 1a; the end of the first winding 28 and the end of the second winding 29 form the common end 30, and connected to the power of negative, the head of the first winding 28 (LA) connects to inverter shown in FIG. 3, the head of the second winding 29 (LB) connects to inverter shown in FIG. 4; the head of the third winding 31b connects to I1+ shown in FIG. 6, the end of the third winding 31a connects to I1− shown in FIG. 6, the head of the fourth winding 32b connects to I2+ shown in FIG. 6, the end of the fourth winding 32a connects to I2.

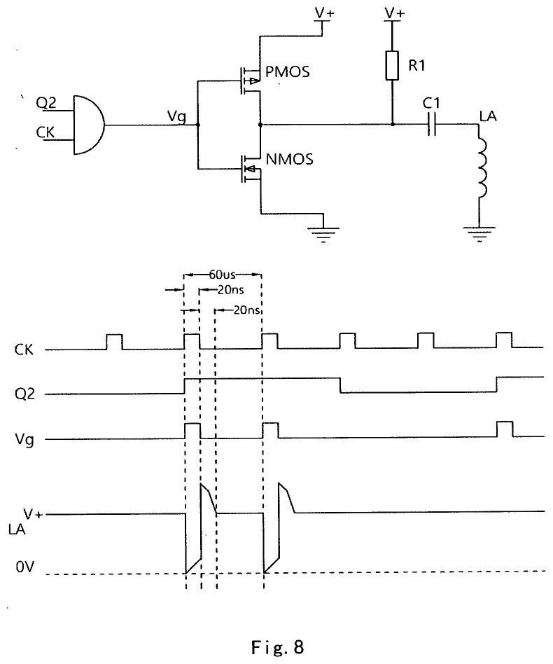

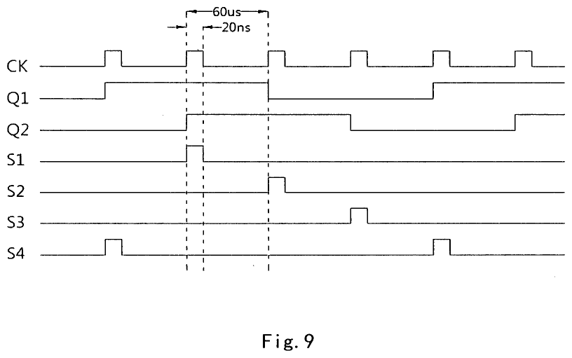

Shown in FIG. 8 and FIG. 9, in the circuit of the actuated winding coil of electronic devices, the clock signal CK and a second signal Q2 couples by logic circuit, receive signal Vg, forms a CMOS inverter by an NMOS transistor and a PMOS transistor, S polarity of the PMOS transistor connects positive V+, S polarity of the NMOS transistor connects power negative, G polarity of the two transistors connects together, input signal Vg, D polarity of the two transistors connects together, also connects a pull-up resistor R1 into V+, in series with a capacitor C1 simultaneous, on the opposite side of the capacitor connected to the end of the coil LA, on a separate side of the coil connected to power negative.

When CK and Q2 is high voltage level, signal Vg is high voltage level (about 20 ns continuous), NMOS transistor conduction, PMOS transistor disconnect, disconnect instantly C1 as conduction LA switch to power negative, voltage rating from V+ to 0V, rapidly due to the coil another terminal voltage of 0 V, V+ cross the resistor R1 and conduction of C1 and the coil and power negative, forms a short circuit of discharge, a temporary electrical current I crosses the coil (from V+ to power negative), continue to about 20 ns, CK becomes a low voltage level, and couples with Q2 (high voltage level) to becomes low voltage level Vg, disconnect the NMOS transistor, PMOS transistor conduction, LA switches to the V+ and voltage rises rapidly, and because the coil on the energy storage is not released, the temporary current where the V+ crosses coil LA does not drop zero, will form an additional voltage, lead to LA on the voltage higher than V+, duration is determined by the inductance and PMOS transistor equivalent resistance, generally less than 20 ns, when released empty energy of the storage in the coil, LA voltage rises to V+, finally, a pulse of around 20 ns is formed on the first drive winding coil.

In the above embodiment, the energy loss can be reduced by adjusting the resistance value of R1 and the capacity of C1, which can have a certain effect on the structure of the scale and winding elements.

The drive circuit of the second drive on the winding coil LB is the same with LA, but because of a the dislocation on the physical location (cross winding) between the first drive winding and the second drive winding, so the LB formed on the drive pulse and LA on the existence of the phase difference.

According to the above embodiment, clock signal CK and the first signal Q1, and the second signal Q2 crosses after four logic gate, get the third signal S1, the fourth signal S2, the fifth signal S3, the sixth signal S4, such as shown in FIG. 8, S1, S2, S3, S4 is square wave which peak value is 20 ns and the cycle is 4T (240 us), and the phase difference is 1T (60 us), thus the periodic control of 8 TG switches is controlled on or off, is sampled four times in a row, continues four clock cycles, respectively, to the ends of the third sensing windings and fourth sensing windings (I2+, I1, I2+, I1−) according to the positive and negative combination of each sampling time, crosses the signal amplifier 30, and band-pass filter 31 processing, can eventually form a phase of the transformation of the scale of mobile real-time periodic position signal AF.

To confirm, the first winding 6 and the second winding 7 in the invention along the grid displacement in the direction of distribution optimization is T/2, the third winding 3 and the fourth winding 4 along the grid displacement in the direction of distribution optimization is T/2, scale upper and lower two rows of grid along the grid distribution direction offset each other optimization is T/2 wherein T/2 can be also used as other reasonable values. The specific value of T/2 should be determined according to the actual situation.

In another embodiment of the Inductive Displacement Sensor of the present invention is a coolant proof sensor.

In another embodiment of the present invention is a coolant proof displacement sensor.

In another embodiment of the present invention it is indicated that the new coolant proof displacement sensor provided by the invention includes a winding terminal.

In another embodiment of the present invention it is indicated that the new coolant proof displacement sensor provided by the invention in the actual application shall be as short as possible sufficient to make measurement.

The present invention provides the scale of inductive displacement sensor with two rows parallel to the uniform distribution of conductive grid structure, the horizontal spacing between two adjacent grids is T, upper and lower two grids along the grid distribution direction are offset of each other T/2. When each winding only cover the location of the grid T/2, the minimum coupling strength however, when ascending grid only covered by winding T/2 position, the grid relatively offset downward T/2 is maintained to provide sufficient coupling strength.

The drive elements and sensing windings elements of the present invention provide inductive displacement sensors capable of being independent of each other. In one embodiment, the drive winding element and the sensing winding elements along the direction of grid parallel distribution, wherein the drive winding element and the two sensing winding elements face to each other as distribution scale, with partial overlapping.

In another embodiment, the drive winding element and the sensing winding elements along the direction of grid parallel distribution, wherein the drive winding element and the two sensing winding elements face to each other as distribution scale, wherein the drive winding element is separated from the two sensing winding elements.

In another embodiment, the drive winding element and the two sensing winding elements are distributed along the circular direction of the fan-shaped lattice, wherein the drive winding element and the two sensing winding elements face to each other as distribution scale, wherein the drive winding element is separated from the two sensing winding elements, wherein the direct coupling between the drive winding element and the sensing winding element is reduced during use, so as to weaken the inhomogeneity of assembling clearance error, and to a certain extent reduces the distortion measurement to enhance the stability of the sensor and measuring accuracy of the improved the stability of the sensor and measurement accuracy.

The term “including” and “include” or any of its other variants is intended to cover a non- exclusive contain, which includes a series of elements of the process, method, item or equipment not only includes those elements, but also no clear list of other elements, or also includes objects and the process, method, or device inherent elements. In the absence of more restrictions, the statement “includes a . . . , describes the elements of a finite element and are not excluded from the process, methods, objects, or equipment contained in the elements.

Still other objects, features, and attendant advantages of the present invention will become apparent to those skilled in the art from a reading of the detailed description of embodiments herein, constructed in accordance therewith, taken in conjunction with the accompanying drawings.

We claim:

1. An apparatus, comprising: a scale and winding element; wherein said described scale is a conductor with two lines of parallel and uniform distribution; wherein horizontal spacing between two adjacent grid forms a shape of a letter T; wherein upper and lower two grids along the grid distribution direction are offset of each other; wherein said scale and said winding element are movable relative to the direction of the grid distribution; wherein said winding element faces said scale; wherein said winding element include a first winding, a second winding, a third winding and a fourth winding; wherein said first winding and said second winding constitute the drive winding elements; wherein said third winding and said fourth winding constitute two sensing winding elements; wherein said drive winding elements are respectively covered on an upper and a lower two row gauge grids, and said two sensing winding elements are respectively covered on two rows of scale, wherein said upper and lower two line gauge grids are respectively covered partly by said drive winding elements, and the two lines of scale are respectively covered by said two sensing winding; wherein said end of the first winding is connected with said end of said second winding, and formed common end is connected with a power negative; wherein both the sensing windings and the drive windings have a space cycle of 2T along the grid distribution, and aligned along the grid distribution.

2. The apparatus of claim 1, further comprising the feature wherein the described scale is a conductor with two lines of grids in parallel and uniform distribution, and the horizontal spacing between two grids between the two grids is T, and upper and lower two grids along the grid distribution direction are offset to each other T/2.

3. The apparatus of claim 1, further comprising a new type of inductive displacement sensor, the feature is that first and the second windings in the description along described grid distribution direction are offset each other T/2 and cross winding to form drive winding element; the three windings and the fourth winding are offset T/2 along grid distribution direction and cross winding to form the two sensing winding elements, which have the same pattern; the two sensing windings are parallel to the driver winding elements.

4. The apparatus of claim 1, further comprising the feature wherein the driving winding element is overlapped with two parts of the sensing winding elements.

5. The apparatus of claim 1, further comprising the feature of two sensing windings elements along the direction perpendicular to the grid distribution described distributed in both sides of the drive winding element.

6. The apparatus of claim 1, further comprising electronic devices, a CMOS inverter composed of at least a NMOS transistor and a PMOS transistor, two D polar of transistor connected together, D polar and resistance and capacitance and drive winding constitute pulse circuits.

7. The apparatus of claim 1, further comprising electronic device, at least an NMOS transistor and at least a PMOS transistor form a CMOS reverser, two D polar of transistor connected together, D polar and drive winding constitute pulse circuits.

8. The apparatus of claim 1, further comprising at least four logic gates, including electronic device, control of at least eight TG switches periodically, wherein a cycle of sampling voltage sequence is four times, sufficient to determine the phase of the sampling signal, and the displacement produced by a linear change of space harmonic coupling may be neglected.

9. The apparatus of claim 1, further comprising a feature wherein the sampling signal processed through a band-pass filter, forms signals, the phase of which varied periodically according to relative displacement between the scale and winding elements described above.
